(19) United States
(12) Patent Application Publication
(10) Pub. No.: US 2024/0371532 A1
(43) Pub. Date: Nov. 7, 2024

(54) A Device That Generates Sustained Nuclear Fusion By Emulating The Physics Of Ball Lightning

(71) Applicant: Jon Allan Magnuson, Irvine, CA (US)

(72) Inventor: Jon Allan Magnuson, Irvine, CA (US)

(21) Appl. No.: 18/310,159

(22) Filed: May 1, 2023

(51) Int. Cl. G21B 1/05

(52) U.S. Cl. CPC G21B 1/05

(57) ABSTRACT

A nuclear fusion power reactor could provide an almost limitless source of energy with minimal greenhouse gas by-products. Remarkably, Ball Lightning produces gamma ray beams, a secondary product of nuclear proton-proton fusion, which is evidence that Ball Lightning produces sustained nuclear fusion. Ball Lightning is an entity formed in a rare situation when two different types of lightning, happening in sequence, produce an enhanced abundance of free protons which are necessary to form Thin Current Sheets in an upward lightning channel. The Thin Current Sheets form a vortex in a knot within the lightning channel and a toroidal structure is formed when the magnetic fields reconnect. This patent invention describes the Ball Lightning Physics Model and then the form and function of a device which will emulate the physics of Ball Lightning. When the device is operated in a laboratory environment, it will generate sustained nuclear fusion.

### RELATED U.S. APPLICATION DATA

Continuation-in-part of U.S. application No. 63/350,799 filed Jun. 9, 2022, the entire contents of the application being incorporated herein by reference.

### REFERENCES CITED

### U.S. Patent Documents

U.S. Pat. No. 4,244,782-A Dow 1981
US20140312770-A1 Seward 2014
U.S. Pat. No. 10,201,070-B2 Seward 2019
US20190295733-A1 Pais 2019

### OTHER PUBLICATIONS

[1] Joseph R. Dwyer, Martin A. Uman, The physics of lightning, Physics Reports, Volume 534, Issue 4, 2014, Pages 147-241, ISSN 0370-1573, DOI: 10.1016/j.physrep.2013.09.004.
[2] US Director of National Intelligence, Preliminary Assessment: Unidentified Aerial Phenomenon, July 2021, https://www.dni.gov/files/ODNI/documents/assessments/Prelimary-Assessment-UAP-20210625.pdf
[3] C. Chen, R. Pakter, D. C. Seward, Equilibrium and Stability Properties of Self-Organized Spiral Toroids, Physics of Plasmas, 8, 4441 September 2001, DOI 10.1063/1.1400792
[4] L. M. Zelenyi, H. V. Malova, E. E. Grigorenko, V. Yu Popov, E. M. Dubinin, Universal Scaling of Thin Current Sheets, Geophysical Research Letters, 20 Jun. 2020, DOI 10.1029/2020GL088422
[5] Tom A. Warner/ztresearch.blog, Personal Communication, 2020
[6] Cen, Jianyong; Yuan, Ping; Xue, Simin., Observation of the Optical and Spectral Characteristics of Ball Lightning, Physical Review Letters. 112, Issue 3, January 2014, DOI: 10.1103/PhysRevLett. 112.035001
[7] S. Marjanovic and J. Cvetic, “Conductivity of a Lightning-Channel Corona Sheath During Return Stroke,” in IEEE Transactions on Plasma Science, vol. 37, no. 6, pp. 750-758, June 2009, DOI: 10.1109/TPS.2009.2016202.
[8] US Department of Energy, Office of Science https://www.energy.gov/science/articles/solving-plasma-physics-mystery-magnetic-reconnection/Oct. 3, 2018, downloaded Apr. 11, 2023.
[9] Wada, Y. and Matsumoto, T. and Enoto, T. and Nakazawa, K. and Yuasa, T. and Furuta, Y. and Yonetoku, D. and Sawano, T. and Okada, G. and Nanto, H. and Hisadomi, S. and Tsuji, Y. and Diniz, G. S. and Makishima, K. and Tsuchiya, H., Catalog of gamma-ray glows during four winter seasons in Japan Phys. Rev. Res., volume 3, issue 4, November 2021, DOI: 10.1103/PhysRevResearch.3.043117
[10] Eric G. Adelberger and Sam M. Austin and John N. Bahcall and A. B. Balantekin and Gilles Bogaert and Lowell S. Brown and Lothar Buchmann and F. Edward Cecil and Arthur E. Champagne and Ludwig de Braeckeleer and Charles A. Duba and Steven R. Elliott and Stuart J. Freedman and Moshe Gai and G. Goldring and Christopher R. Gould and Andrei Gruzinov and Wick C. Haxton and Karsten M. Heeger and Ernest Henley and Calvin W. Johnson and Marc Kamionkowski and Ralph W. Kavanagh and Steven E. Koonin and Kuniharu Kubodera and Karlheinz Langanke and Tohru Motobayashi and Vijay Pandharipande and Peter Parker and R. G. H. Robertson and Claus Rolfs and R. F. Sawyer and N. Shaviv and T. D. Shoppa and K. A. Snover and Erik Swanson and Robert E. Tribble and Sylvaine Turck-Chi and John F. Wilkerson, Solar fusion cross sections, Reviews of Modern Physics, October 1998, volume 70, number 4, pages 1265-1291, DOI: 10.48550/arXiv.astro-ph/9805121
[11] Ji, X., Yuan, F. & Zhao, Y. What we know and what we don't know about the proton spin after 30 years. Nat Rev Phys 3, 65 (2021). DOI: 10.1038/s42254-020-00248-4
[12] Liu, KF. Status on lattice calculations of the proton spin decomposition. AAPPS Bull. 32, 8 (2022). DOI: 10.1007/s43673-022-00037-4
[13] Dwyer, J., Smith, D., Hazelton, B., Grefenstette, B., Kelley, N., Lowell, A., . . . . Rassoul, H. (2015). Positron clouds within thunderstorms. Journal of Plasma Physics, 81 (4), 475810405. DOI: 10.1017/S0022377815000549
[14] Daniele Telloni and Gary P. Zank and Marco Stangalini and Cooper Downs and Haoming Liang and Masaru Nakanotani and Vincenzo Andretta and Ester Antonucci and Luca Sorriso-Valvo and Laxman Adhikari and Lingling Zhao and Raffaele Marino and Roberto Susino and Catia Grimani and Michele Fabi and Raffaella D'Amicis and Denise Perrone and Roberto Bruno and Francesco Carbone and Salvatore Mancuso and Marco Romoli and Vania Da Deppo and Silvano Fineschi and Petr Heinzel and John D. Moses and Giampiero Naletto and Gianalfredo Nicolini and Daniele Spadaro and Luca Teriaca and Federica Frassati and Giovanna Jerse and Federico Landini and Maurizio Pancrazzi and Giuliana Russano and Clementina Sasso and Ruggero Biondo and Aleksandr Burtovoi and Giuseppe E. Capuano and Chiara Casini and Marta Casti and Paolo Chioetto and Yara De Leo and Marina Giarrusso and Alessandro Liberatore and David Berghmans and F. Auchre and Regina Aznar Cuadrado and Lakshmi P. Chitta and Louise Harra and Emil Kraaikamp and David M. Long and Sudip Mandal and Susanna Parenti and Gabriel Pelouze and Hardi Peter and Luciano Rodriguez and Udo Schuhle and Conrad Schwanitz and Phil J. Smith and Cis Verbeeck and Andrei N. Zhukov, Observation of a Magnetic Switchback in the Solar Corona, The Astrophysical Journal Letters, Vol 936, Num 2, September 2022, DOI: 10.3847/2041-8213/ac8104.

### STATEMENT REGARDING FEDERALLY SPONSORED RESEARCH OR DEVELOPMENT

This invention was made without government support. Therefore, the federal government is without rights to this invention.

### BACKGROUND OF THE INVENTION

Statement of the field of endeavor to which the invention pertains to G21B 1/05 Thermonuclear fusion reactors with magnetic or electric plasma confinement, is the subject matter of the claimed invention.

Nuclear fusion research has been on-going since the 1940s. A nuclear fusion power reactor could provide an almost limitless source of energy with minimal greenhouse gas by-products. However, to be useful, a nuclear fusion power plant would need to be both controllable and produce sustained nuclear fusion over a significant period of time. A multitude of different thermal nuclear fusion approaches have been attempted, for example U.S. Pat. No. 4,244,782-A titled Nuclear Fusion System by Dow 1981. And cold fusion approaches have been attempted, see patent US20190295733-A1, titled Plasma Compression Fusion Device, by Pais 2019. Neither the thermonuclear nor cold fusion approaches have produced the necessary mechanism to generate sustained and controlled nuclear fusion over timescales long enough to be useful. On the other hand, recent scientific observations provide convincing evidence that Ball Lightning is undergoing sustained nuclear fusion. The inference within this application is that nuclear fusion is generated in Ball Lightning's magnetic pinch region with the assistance of a concept introduced in this application called Quantum Spin Coupling. The device described in this patent application can emulate the Physics of Ball Lightning in a laboratory and thereby generate sustained nuclear fusion in a laboratory environment.

Lightning is a widely recognized natural phenomena, but Ball Lightning is still poorly understood. One of the top ten questions in lightning research is, “What is the physics of ball lightning?” [1] Dwyer 2014, page 157. The existence of Ball Lightning used to be questioned but has recently been supported by the release of videos, taken by military pilots, of luminescent objects flying in the terrestrial atmosphere. The Unexplained Aerial Phenomenon (UAP) report was released in 2021 by the [2] US Director of National Intelligence 2021. Some of the objects are very likely to be Ball Lightning. The content of this patent application provides the properties associated with Ball Lightning and hypothesizes a Ball Lightning Physics Model.

The Ball Lightning Physics Model assumes Ball Lightning is an entity formed in the rare situation when a sequence of two different, uncommon types of lightning produces an enhanced abundance of free protons. The enhanced proton abundance allows a set of nested Thin Current Sheets (TCS) of protons and electrons to transform into a toroidal configuration, see FIG. 1. A Thin Current Sheet of electrons 101 is rotating counterclockwise 105 in the opposite direction of a Thin Current Sheet of protons 102 which is rotating clockwise 106 in the right hand side of the toroid. Both Thin Current Sheets are moving at relativistic speeds. A nearly uniform constant magnetic field fills the toroidal shape, with the magnetic field 103 pointing into the page and magnetic field 104 pointing out of the page. There is air inside the toroidal entity, but the air is not restrained by the two nested current sheets. The magnetic field energy from the lightning has been accumulated and is then slowly released over the next seconds to minutes. The plasma includes nearly equal amounts of electrons and protons such that the entity is essentially charge neutral. It contains large internal electric currents and their associated internal magnetic fields arranged so that the forces within are nearly balanced. The plasma described herein is observed to be formed at ambient atmospheric pressure and is observed to be self-stable with no external magnetic containment. The protons within the plasma undergo nuclear fusion, which continues for several seconds to minutes.

Over the centuries Ball Lightning has been observed to display many disparate properties. This patent application assumes Ball Lightning has the following 9 attributes and/or properties. Then a hypothetical Ball Lightning Physics Model explains how this set of interconnected attributes and/or properties are understood by reference to a comprehensive physics model of Ball Lightning. Ball Lightning's nine (9) attributes and/or observed properties include:
1. Ball Lightning has captured some of the magnetic energy from a lightning strike.
2. Ball Lightning rarely forms even though lightning is common.
3. Ball Lightning floats through the atmosphere for seconds to minutes.
4. Ball Lightning sometimes explode at the end of life.
5. Ball Lightning forms without the aid of external magnetic confinement.
6. Ball Lightning sometimes exhibit Gamma Ray Beams which last for minutes.
7. Ball Lightning generates nuclear fusion assisted by Quantum Spin Coupling.
8. Ball Lightning can sometimes fly through walls.
9. Ball Lightning can travel at relativistic speeds.

The Ball Lightning Physics Model in this patent explains all 9 attributes and/or properties of Ball Lightning in a comprehensive way.

Property 1) Ball Lightning has captured some of the magnetic energy from a lightning strike. [3] Chen 2001 defined “a cold-fluid model for a self-organized electron spiral toroid (EST) in partial atmosphere, assuming a) the electrons undergo energetic spiral motion along a hollow torus with an ion background, b) the electron mean free path is long compared with the EST size, c) the electron temperature is low, d) the ion background is assumed to be fixed, and e) the minor radius of the EST is small when compared with the major radius”. Using this model, the equilibrium and stability properties of the electron flow in the self-organized EST were solved numerically with a computer code. It was found that a class of self-organized EST equilibria exist in absence of any applied toroidal magnetic field and are stable at high electron densities.

Then Seward 2014 patent US20140312770-A1 showed that a self-organized Electron Spiral Toroid Spheromak (ESTS) was created in a partial vacuum and observed for hundreds of milliseconds. The electrons form a magnetically self-contained plasma toroid as long as two constraints are met: 1) there have to be enough electrons 2) there have to be enough ions in the vicinity to balance the charge of the electrons.

The Ball Lightning Physics Model within this current patent application extends beyond the EST and ESTS models proposed by Chen 2001 and Seward 2014. The current inventor's Ball Lightning Physics Model hypothesizes that Ball Lightning is a plasma toroid made of both electron and proton Thin Current Sheets (TCS), see FIG. 1. TCS are pulled together by both Lorentz and coulomb forces, see FIG. 2. When a positive current 201 of protons 202 moves in a positive direction 203 a magnetic force 204 labeled B is created. And when a positive current 205 of negative charged electrons 206 moves in the negative direction 207 a similar magnetic force 208 labeled B is formed. The two currents are pulled together by their magnetic forces, called the Lorentz force 209. The two currents are also pulled together by their mutual coulomb force 210 because oppositely charged particles are attracted to each other.

According to [4] Zelenyi 2020 Thin Current Sheets play an important role in various space plasma configurations. Numerous satellite measurements in space indicate that these magneto-plasma structures are responsible for the processes of magnetic field energy accumulation and subsequent fast release (e.g., solar flares and magnetospheric substorms) due to the beginning of fast reconnection processes. Ball Lightning Physics Model conclusion 1: Lightning magnetic energy has been temporarily captured and carried away in a set of two counter rotating Thin Current Sheets in the shape of a toroid.

Property 2) Ball Lightning rarely forms even though lightning is common. Ball Lightning forms under very specific (rare) conditions. There are four (4) general types of lightning between the clouds and the ground, see [1] Dwyer 2014, page 151. These four types of lightning are classified depending on the lightning leader direction, up or down, and the leader charge, positive or negative. First, the most common type of lightning, hereby called Type A for the convenience of this discussion, are negative leaders going downward from the clouds to the ground. Type A lightning occur about 90% of the time. Second, Type B lightning, which are exceedingly rare, are positive leaders which go from the ground upward to the clouds. Third, Type C lightning, are positive leaders that go downward from clouds to the ground that occur about 10% of the time. Type C lightning comes from the top of clouds and are often the most powerful form of lightning. They can sometimes strike miles away from the thunderstorm and are the origin of the term “bolt out of the blue”. Fourth, Type D lightning are a rare type of negative leaders that go up from the ground to the clouds. The most important finding about, Type B, upward positive lightning is that the upward positive leader primarily occurs after there has been a nearby precursor Type C positive cloud-to-ground lightning, [5] Warner 2020. The Ball Lightning Physics Model assumes that Ball Lightning are formed from a sequence of a Type C lightning followed by a Type B lightning. The electric field change caused by the preceding Type C downward positive lightning enhances the local proton density near the top of a hill, building, tower, or metal object. The enhanced proton abundance allows for an electrically balanced set of Thin Current Sheets (TCS) to form in the Type B positive upward lightning channel. A partial validation of this one-two-punch lightning sequence concept was observed when a Ball Lightning spectrum was collected serendipitously on the Tibetan Plateau, described by [6] Cen 2014. Spectral analysis indicated that soil constituents, Si I, Fe I, and Ca I lines, contribute the majority of bright light, while air compositions, N I and O I lines, dominate the periodic feature of the Ball Lightning. There are some differences between the temperature values estimated from the spectral lines of different elements in the spectrum. The temperature was estimated to be from 7,170 to 11,410 degrees Kelvin. The hypothesis of this Ball Lightning Physics Model is that soil was kicked up by a Type C, “bolt out of the blue lightning”. Then some of this soil was caught up in the Type B positive upward lightning channel. A further subset of this soil was incorporated into the Ball Lightning when it was formed. The Ball Lightning Physics Model conclusion 2: Ball Lightning only forms in the rare situation when a sequence of two uncommon types of lightning produces an enhanced abundance of free protons. The proton abundance is necessary to form Thin Current Sheets in the upward Type B lightning channel. The Thin Current Sheets are necessary to successfully form a toroidal structure and capture some of the magnetic energy of the Type B lightning.

Property 3) Ball Lightning float in the air for seconds to minutes. The Ball Lightning Physics Model assumes that the magnetic energy held within the TCSs, see Property 1, is slowly radiating energy to its surrounding environment. The captured lightning energy will decay over the intervening seconds to minutes, and the Ball Lightning will collapse. Ball Lightning Physics Model conclusion 3: Ball Lightning has stored magnetic energy, which is radiated away over seconds to minutes, and then the Ball Lightning will collapse.

Property 4) Ball Lightning sometimes explode at the end of life. Since Ball Lightning are constantly radiating, they eventually radiate their captured lightning magnetic energy until their structure cannot be maintained. When the nested TCS break down, protons and electrons rejoin to form atomic and molecular hydrogen with an explosive release of energy. Ball Lightning Physics Model conclusion 4: Ball Lightning is made up of only electrons, protons, and electromagnetic fields, which sometimes explosively form molecular and atomic hydrogen.

Property 5) Ball Lightning form without the aid of external magnetic confinement. Lightning is famous for following a torturous path through the atmosphere. Therefore, knots will form within the lightning channel. Additionally, the lightning channel cross section conductivity [7] Marjanovic 2009 varies across the width of the channel, see 301 in FIG. 3. The conductivity 301 within the lightning channel varies substantially, with the largest conductivity usually existing at the outer regions of the lightning channel. When a bulge 302 forms in the lightning channel the two current sheets 303 and 304 continue to be held together by the Lorentz 305 and coulomb 306 forces but they are warped by the uneven channel conductivity. The curved current paths induce a magnetic field 307, labeled B. The induced magnetic field will, in turn, amplify the vortex. If the vortex is strong enough, the magnetic fields reconnect. Then the Thin Current Sheets will fall into a minimum energy configuration described as a nested Thin Current Sheets toroid, which is in effect Ball Lightning.

According to [8] US Department of Energy 2018, magnetic reconnection is a process that occurs nearly anywhere there's plasma; however, it is poorly understood. In 2007, Nuno Loureiro proposed a plasmoid instability model. The plasmoid instability model starts with a stretched-out, thin sheet of electrical current with an accompanying magnetic field. Like the two-fluid model, it assumes the electrons and ions that flow along the magnetic field lines break away at different times. What makes this model different is that the sheets of electrical current are extremely unstable. As the sheets stretch, they break and form new ones, each thinner than the original. As these sheets separate, chains of magnetic bubbles (plasmoids) form between them. The theory proposes that as more bubbles form and sheets break up, the magnetic lines crash into each other and break. The lines disconnect from the ions first, then the electrons. The breaking feeds magnetic energy into the particles, heating them up and accelerating them. As time goes on, the whole process becomes faster and faster. It creates a runaway effect and fast reconnection. In this case, the terrestrial lightning causes these thin sheets of protons and electrons to be accelerated to relativistic speeds. Ball Lightning Physics Model conclusion 5: Ball Lightning is formed by a chaotic vortex process producing an equilibrium minimum potential energy nested set of Thin Current Sheets in the form of a toroid.

Property 6) Ball Lightning sometimes generate Gamma Ray Beams. In an independent set of scientific observations, [9] Wada 2021 document a catalog of 70 Gamma Ray Glows which have been detected over 4 years. Wada reported that Gamma Ray Glows are rare events formed within thunderclouds and have been observed to beam 27 MeV Gamma Rays within the terrestrial atmosphere. Wada also reported Gamma Ray Glows float in the wind at approximately 3 km altitude, last for an average of about a minute, and sometimes generate lightning at their end of life. These Gamma Ray Glows have all five of the properties which are listed above for Ball Lightning. Therefore, the Ball Lightning Physics Model hypothesizes that Gamma Ray Glows and Ball Lightning are one in the same.

The most convincing evidence that Gamma Ray Glows are Ball Lightning is that 19 out of the 70 (27%) of the Gamma Ray Glows, reported by Wada 2021, were terminated with a lightning discharge. The implication is that Gamma Ray Glows are entities carrying magnetic energy generated in the thunder cloud; are producing high energy Gamma Rays for an average of 33.5 seconds; then they suddenly stop producing Gamma Rays when they release their accumulated energy in the form of a detectable lightning discharge. The Ball Lightning Physics Model assumes that Gamma Ray Glows are Ball Lightning which have accumulated energy from a lightning event, produced Gamma Rays for seconds or minutes and then released that same energy in the form of lightning. One significant difference is that Gamma Ray Glows are observed in gamma ray wavelengths, instead of visible wavelengths used to observe Ball Lightning. This difference is acceptable because the entities are so rare that there hasn't been a situation where both gamma ray sensors and visible sensors have been operating at the same time that the Ball Lightning entity appeared. Ball Lightning Physics Model conclusion 6: Ball Lightning generate high energy gamma ray beams.

Property 7) Ball Lightning generates nuclear fusion assisted by Quantum Spin Coupling. This Ball Lightning Physics model hypothesizes that the source of the Gamma Ray beams is due to sustained proton-proton nuclear fusion (PP nuclear fusion) within the Magnetic Pinch Region 401 of Ball Lightning, see FIG. 4. In the drawing exploded view, two protons 402 and 403 are traveling upward on parallel paths with their spin axis aligned in opposite directions. Occasionally, with the help of Quantum Spin Coupling, the two protons will tunnel through their mutual coulomb barrier and form a diproton 404. Sometimes the diproton will decay into a deuterium (a proton P and neutron N) 405, positron 406, and neutrino 407, which is the simplest form of nuclear fusion. Once a positron is formed, it moves into the outer electron toroidal plasma shell where it will rotate in a direction opposite to the electrons 408. When a positron 406 and electron 408 collide, matter antimatter annihilation 409 generates gamma rays which beam perpendicular to the plane of the Ball Lightning toroid. Matter antimatter annihilation would only produce 1.02 MeV of energy if the two particles annihilated at rest; however, since both the positron and electron particles are moving towards each other at 98% of the speed of light, 27 MeV gamma rays 410 and 411 are generated. The gamma rays are beamed perpendicular to the plane of the Ball Lightning.

This inventor introduces a concept, called Quantum Spin Coupling (QSC), as a way to explain how protons get over their mutual coulomb barrier and fuse into diprotons 404. Any scientist who proposes that Quantum Spin Coupling enables low temperature, 10,000 degree K, sustained nuclear fusion must discuss Occam's Razor. Occam's Razor is a principle of theory construction according to which, other things equal, explanations that posit fewer entities are to be preferred to explanations that posit more. With subatomic particles, we sometimes see the end products of a process and infer the underlying process that created the products without directly observing the process. There are three classes of subatomic quantum phenomenology where this occurs: 1) Quantum Mechanics 2) Quantum Tunneling 3) Quantum Spin Coupling.

Quantum Mechanics was the first subatomic quantum phenomenon to be understood. Before Quantum Mechanics was hypothesized in the 1920s, some of the earliest clues about the necessity of quantum mechanics over classical physics came from the observation of the quantization of energy between electrons and atomic nuclei. The phenomenology of quantum physics arose between 1895 and 1915. And for the following years, before the development of quantum mechanics around 1925, physicists continued to think of quantum theory within the confines of what is now called classical physics, and in particular within the same mathematical structures. Quantum Mechanics, a new mathematical formulation, was developed to successfully characterize the interaction between electrons and atomic nuclei. For example, the hydrogen alpha emission line wavelength is precisely 656.46 nm, no matter where or when the emission line was formed. We can clearly see the end product, the quantum energy in emission lines, and confidently infer that the underlying process is quantized at the subatomic scale.

Quantum Tunneling was the next subatomic quantum phenomenon to be understood. Before Quantum Tunneling was hypothesized, classical physics had a significant issue trying to model solar nuclear fusion. With classical physics there is almost no possibility for protons to cross their mutual Coulomb barrier and fuse by the brute force of the 15.7 million degree thermal energy commonly assumed to be at the center of the sun. When subatomic Quantum Tunneling is invoked [10] Adelberger 1998, the solar PP nuclear fusion rate is reasonable, while the coulomb barrier still presents a high threshold which is used as an argument for why the Sun doesn't rapidly fuse all its hydrogen and quickly burn out. We can clearly see the end product, sunshine, and can confidently infer that Quantum Tunneling is happening because it posits fewer assumptions for a complicated process that we see in stars.

A third subatomic quantum phenomenon called Quantum Spin Coupling (QSC) is proposed in this patent to assist PP nuclear fusion and overcome the mutual coulomb barrier of two protons within the magnetic pinch region of Ball Lightning. There are still mysteries about proton quantum spin energy, see [11] Ji 2021 and [12] Liu 2022. The apparent nuclear fusion products indicate that the Quantum Spin Coupling is making a significant contribution, even though the mathematical formulism hasn't been defined, as of yet.

There are three places, outside the stars, where Quantum Spin Coupling likely helps explain the origin of PP nuclear fusion within Thin Current Sheets. PP nuclear fusion is likely evident in 1) Solar wind 2) Positron Clouds 3) Gamma ray beams from Ball Lightning.

The solar wind temperature is a well-known puzzle that could possibly be solved by adopting Quantum Spin Coupling within electron and proton Thin Current Sheets (TCS). The interior of the sun is assumed to be at 15.7 M degrees K, the surface of the sun has a temperature of about 5,800 degrees K, but the solar wind (corona) has an enigmatic temperature of about 1,000,000 degrees K. There are only a few very simple constituents of the solar wind; electrons, protons, and electromagnetic fields. We know from the practice of nuclear Magnetic Resonance Imaging (MRI) that there is always a finite population of protons which have their spins aligned with and against a magnetic field. Spin coupling will help pull the protons over their mutual coulomb barrier when two protons 402 and 403 are spinning in opposite directions, see FIG. 4. Therefore, proton-proton fusion aided by Quantum Spin Coupling in TCSs is the likely explanation for the 1,000,000 degree K solar wind puzzle.

Positron clouds have been observed to form by an enigmatic process. “It is not clear how the positron clouds were created within the thunderstorm, . . . ” [13] Dwyer 2015. The hypothesis in this patent application is that positrons are formed by proton-proton fusion aided by Quantum Spin Coupling in Thin Current Sheets.

Gamma Ray Beams have already been discussed in this paper and are likely to have been created as an end product of PP nuclear fusion enabled by Quantum Spin Coupling.

Relativistic Runaway Electron Avalanches (RREA) have been proposed [9] Wada 2021 as the source of the Gamma Rays, but RREA is an unsatisfactory explanation for two reasons. The first reason is because the RREA dissipate the necessary high voltages far too quickly to last as long as Gamma Ray Glows float in the atmosphere. The second reason to believe that RREA is not the source of Gamma Ray Glows is because the Gamma Ray Glow source must be generated in a small area as seen in the gamma ray intensity curve of catalog event 55 see FIG. 5 used with permission from Wada 2021. The inventor of this patent proposes that the gamma ray intensity curve shows evidence of beam rotation. The left axis of the FIG. 501 is in units of counts per second. The observation time 502 is listed in hour and minutes along the bottom of the chart. The gamma ray beam passes over the gamma ray sensor in a push broom manner, then there is a sharp drop 503 in detections of gamma rays when the Ball Lightning gamma ray beam rotates slightly backward, no longer illuminating the gamma ray sensor. Then the same rotated gamma ray beam makes the gamma ray detections rise a second time 504 because the gamma ray beam is now trailing while the Ball Lightning continues flying in the same left to right direction. See FIG. 6 for a notional explanation for the cadence of the double gamma ray observations. The Ball Lightning is flying with its plane 602 oriented at a fixed angle, and the gamma ray beam 603 is oriented perpendicular to the plane of the Ball Lightning. The Ball Lightning is moving from left to right 604 in a push broom manner. As time 605 continues, listed in hour and minutes, at 2:03 606 the Ball Lightning beam illuminates the gamma ray detector 601. Then the Ball Lightning rotates 607 so the beam no longer illuminates the sensor, the detected intensity drops precipitously (503 in FIG. 5). The beam is still moving from left to right but is now trailing the Ball Lightning. Then as time goes by, just before time 2:06 608 the beam passes over the detector a second time (504 in FIG. 5), gamma ray detections increase again. The continuous minutes long existence of the gamma ray beams implies that the gamma rays are coming from a concentrated energy source and rules out RREA as the source of the Gamma Ray beam.

Ball Lightning rotation is likely due to induction caused by recently discovered solar wind magnetic switchbacks. Magnetic switchbacks [14] Telloni 2022 are sudden reversals in the magnetic field of the solar wind. They can also be described as traveling disturbances in the solar wind that cause the magnetic field to bend back on itself. They were first observed by the NASA-ESA mission Ulysses, the first spacecraft to fly over the Sun's poles. The switchbacks can be short (10s of seconds), long, intermittent, repeated, or solo. The continuous minutes long existence of the gamma ray beams implies a sustained concentrated energy source, like the Ball Lightning Physics Model described within this patent application. We see the end product, gamma ray glows, and can infer that Quantum Spin Coupling is happening because it is the simplest explanation for a very complicated process that we see in Ball Lightning. Ball Lightning Physics Model conclusion 7: Ball Lightning generates nuclear fusion assisted by Quantum Spin Coupling.

Property 8) Ball Lightning can fly through walls. Ball Lightning is made up of only subatomic particles, protons, electrons, and electromagnetic fields. Subatomic particles and electromagnetic fields may be slowed down, but not stopped by walls. Ball Lightning Physics Model conclusion 8: Ball Lightning is made up of subatomic particles that can fly through walls.

Property 9) Ball Lightning can travel at relativistic speeds. As already stated, it is assumed that Ball Lightning is charge neutral, but if a slight charge imbalance exists, Ball Lightning can be accelerated to relativistic speeds by being immersed in an ambient natural electric field which routinely exist in the terrestrial atmosphere. Ball Lightning Physics Model conclusion 9: Ball Lightning is made up of subatomic particles; therefore, the entity can fly at relativistic speeds if there is a charge imbalance in the entity.

### SUMMARY OF THE INVENTION

Ball Lightning is formed when Thin Current Sheets (TCS) capture some of the magnetic energy from lightning. The reason Ball Lightning is so rare is because there needs to be enough free protons to form a proton Thin Current Sheet which stabilize and balance the electron Thin Current Sheet in an upward positive lightning discharge. In terrestrial lightning, there are only enough protons to form Ball Lightning when a rare combination of two types of lightning occurs in sequence. Ball Lightning generates nuclear fusion in its magnetic pinch region with the assistance of Quantum Spin Coupling. The innovation of this invention is the way the device operates in a tank of hydrogen which enhances the density of free protons in a lightning channel in a laboratory emulation of the Ball Lightning Physics Model. The density of free protons is enhanced by irradiating hydrogen with ionizing radiation which cleaves the electrons from the protons. In addition, protons are stored on the surface of a proton generator placed in the bottom of the tank. Steps that follow include: 1. A lightning discharge is implemented. 2. A Ball Lightning is created by a vortex within a knot in the lightning channel. 3. Nuclear fusion happens naturally, aided by Quantum Spin Coupling, in the magnetic pinch region of the Ball Lightning toroidal shaped nested proton and electron Thin Current Sheets.

### BRIEF DESCRIPTION OF DRAWINGS

FIG. 1 is a schematic diagram 100 of a toroidal Ball Lightning plasma entity.

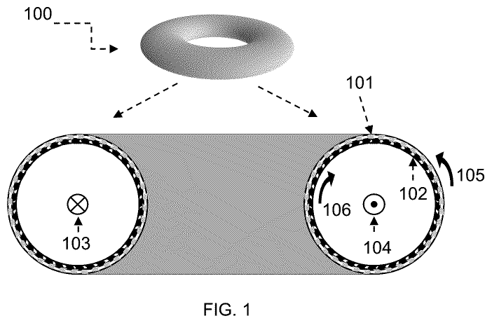

FIG. 2 is a schematic diagram 200 of a side view of the attractive forces between two Thin Current Sheets.

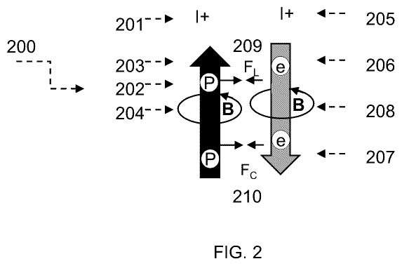

FIG. 3 is a schematic view 300 of a segment of a lightning channel cross section.

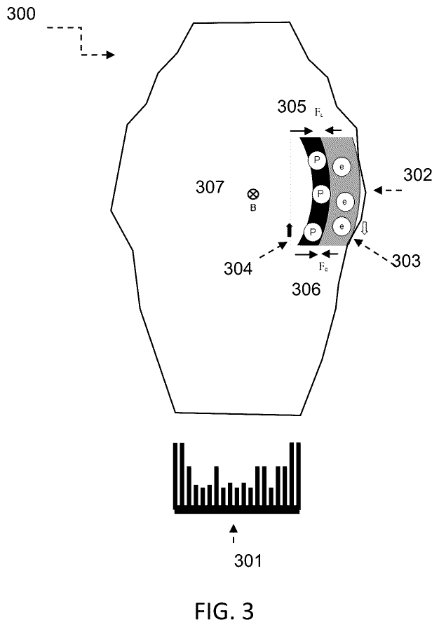

FIG. 4 is a schematic view 400 of the cross section through the magnetic pinch 401 region of the nested Thin Current Sheet toroid.

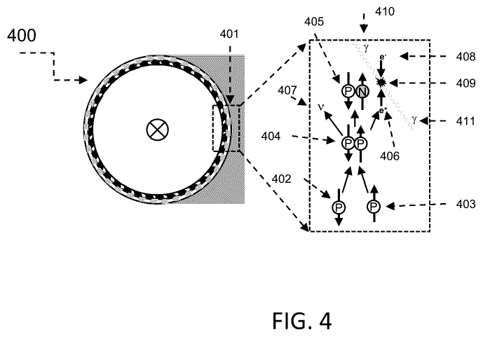

FIG. 5 is the Gamma Ray Glow intensity 500 for object event number 55 reported by Wada 2021, which is one of the 70 Gamma Ray Glows listed in their catalog.

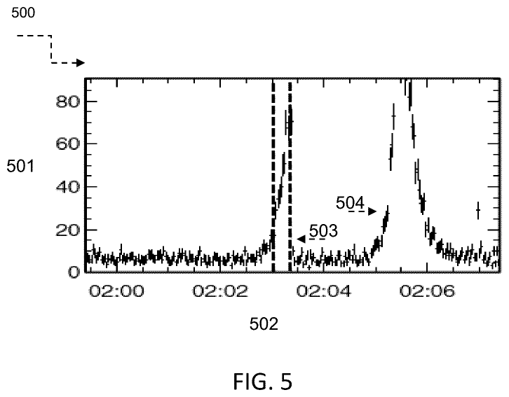

FIG. 6 is a notional chart 600 used to help explain the way a gamma ray detector located in a fixed location 601, can be illuminated twice by the same Gamma Ray Beam.

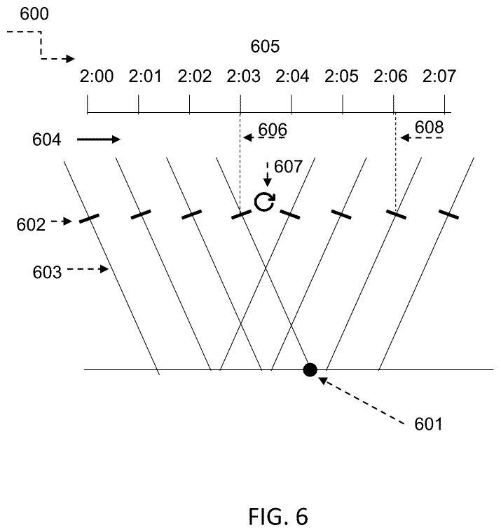

FIG. 7 is a schematic diagram 700 of a view of a preferred embodiment of the invention taken transverse to an initiating conductor.

FIG. 8 is a schematic 800 of the order of operation of the nuclear fusion generation device.

### DETAILED DESCRIPTION OF THE INVENTION

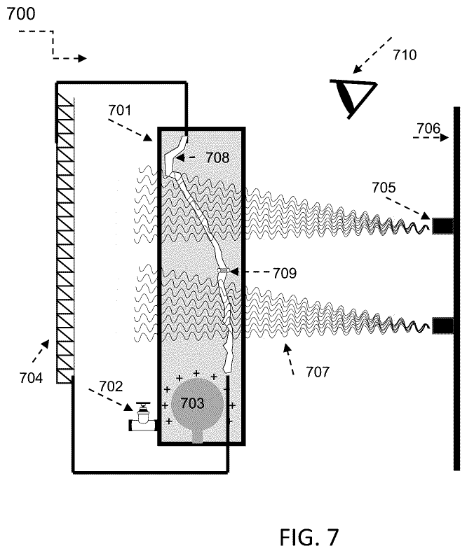

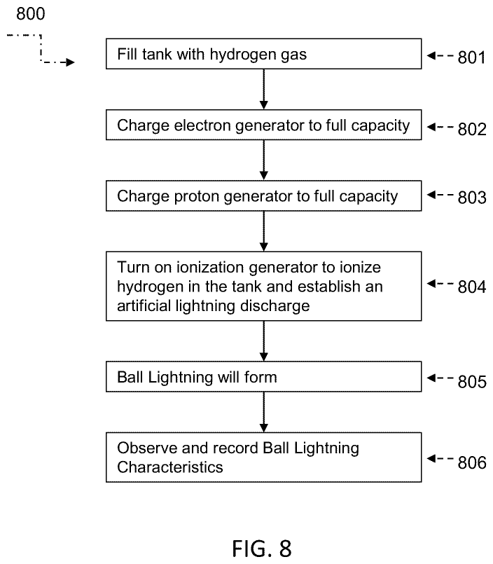

The above, and other features of the invention including various novel details of construction and combination of parts, are described with reference to the accompanying drawings. It will be understood that the particular toroidal shaped nested proton and electron Thin Current Sheets which embody the invention is shown by way of illustration only and not as a limitation of the invention. The invention can also be called a nested toroidal plasma, consisting of counter rotating toroidal electron and proton plasma shells. The particular features of this invention can be employed in various embodiments without departing from the scope of the invention. The equipment, methods, and order of operation of this invention are shown in FIGS. 7 and 8 and now expanded further.

In FIG. 7 a tank 701 is used to hold hydrogen at ambient temperature and pressure. The tank is made of non-conducting material, for example the tank could be made of fiberglass. There will be heat resistant observation ports in the tank to enable the recording of events inside. One or more fill valves 702 will be used to purge and fill the tank with nearly pure hydrogen at ambient temperature and pressure. The hydrogen could contain trace amounts of non-volatile gasses, but no oxygen. A proton charge generator 703 sitting near the bottom of the tank will be charged before the experiment starts. The generator could be a Van de Graaff Generator, for example. There could be 0.1 coulombs of protons stored on the surface of the generator, for example. An electron generator 704 sitting parallel to the tank will have capacitors charged with electricity before the experiment starts. The generator could be a Marx generator, for example. The generator could produce 30 amps of current, for example. One or more hydrogen ionization radiation generators 705 will be mounted on a rack next to the tank. The hydrogen ionization radiation could be x-rays, for example. The rack will allow the height 706 of the ionization radiation equipment to be adjusted to various positions and heights. Ionizing radiation will be beamed 707 through the wall of the tank. Hydrogen ionization will produce a significant number of free protons. The electron charge generator 704 capacitors will be switched on to produce an artificially induced lightning channel 708 between the anode and cathode of the electron generator. Protons will naturally be released from the proton generator 703. Electrons and protons will travel in opposite directions in the lightning channel 708. Two Thin Current Sheets will be produced and be drawn together by both coulomb and Lorentz forces. The curvature of the two current sheets will then induce a self-generated magnetic field vortex 709. Then magnetic fields will reconnect into a minimum energy entity which has the shape of nested toroidal current sheets, called Ball Lightning. Sensors 710 will be placed to see and record the expected Ball Lightning phenomenology. The sensors 710, comprised of visible video cameras, radiation sensors, radio frequency antennas, Geiger counters, and Gamma Ray Sensors, will record the Ball Lightning and gamma rays phenomenology.

FIG. 8 is a schematic 800 of the order of operation of the nuclear fusion generation device. The initial step is to fill the tank with hydrogen gas 801. Next the electron generator will be fully charged 802, followed by the charging of the proton generator 803. The ionizing radiation 804 will be turned on which will generate free protons in the tank and also initialize the artificial lightning discharge. One or more knots will form naturally in the lightning channel 805. A vortex will form in one of the lightning channel knots and then the magnetic field will reconnect creating a set of proton and electron Thin Current Sheets. Nuclear fusion will begin in the magnetic pinch region of the proton Thin Current Sheet. Nuclear fusion will generate positrons which will naturally move into the electron Thin Current Sheet. A positron and electron, moving towards each other at relativistic speeds will annihilate each other and will generate two gamma rays, which will beam perpendicular to the plain of the Ball Lightning. Sensors near the device 806 will record the nuclear fusion byproducts. The detection of gamma rays shall serve as proof of successful nuclear fusion generated by the emulation of the physics of Ball Lightning.

1. A nested toroidal plasma, consisting of counter rotating toroidal electron and proton plasma shells, said device generates sustained nuclear fusion.
